(19) United States
(12) Patent Application Publication
(10) Pub. No.: US 2025/0031036 A1
(43) Pub. Date: Jan. 23, 2025

(54) PROTECTION OF APPLICATION METADATA IN TRANSPORT PROTOCOL

(71) Applicant: Nokia Technologies Oy, Espoo (FI)

(72) Inventors: K. TIRUMALESWAR REDDY, Bangalore (IN); Saurabh KHARE, Bangalore (IN); Ranganathan MAVUREDDI DHANASEKARAN, Munich (DE)

(21) Appl. No.: 18/779,046

(22) Filed: Jul. 21, 2024

(30) Foreign Application Priority Data
Jul. 21, 2023 (GB) 2311188.3

(51) Int. Cl. H04W 12/043; H04W 12/02; H04W 12/06; H04W 76/10

(52) U.S. Cl. CPC H04W 12/043; H04W 12/02; H04W 12/06; H04W 76/10

(57) ABSTRACT

Systems and methods of sending application metadata to on-path network elements. In an embodiment, a method comprises establishing an application session between an application client (1006) running on user equipment (106) and an application service (1010), identifying application metadata (1810) associated with the application session, formatting a transport protocol packet (1802) with the application metadata, deriving an encryption key (1816) based on keying material (1812), encrypting the application metadata in the transport protocol packet using the encryption key, and sending the transport protocol packet over a user plane network path (1024) comprising one or more on-path network elements (1104).

### TECHNICAL FIELD

This disclosure is related to the field of communication systems and, in particular, to next generation networks.

### BACKGROUND

Next generation networks, such as Fifth Generation (5G), denote the next major phase of mobile telecommunications standards beyond Fourth Generation (4G) standards. In comparison to 4G networks, next generation networks may be enhanced in terms of radio access and network architecture. Next generation networks intend to utilize new regions of the radio spectrum for Radio Access Networks (RANs), such as millimeter wave bands.

With mobile networks widely used across the country and the world, communications may be intercepted or suffer from other kinds of attacks. To ensure security and privacy, the 3rd Generation Partnership Project (3GPP) has set forth security mechanisms for 5G mobile networks, and the security procedures performed within the 5G mobile networks. One of the security procedures between User Equipment (UE) and a 5G mobile network is primary authentication and key agreement. Primary authentication and key agreement procedures enable mutual authentication between the UE and the network, and provide keying material that can be used between the UE and the serving network in subsequent security procedures. After primary authentication, a Non-Access Stratum (NAS) security context and an Access Stratum (AS) security context are created for the UE.

Further, an application session may be established between the UE and an application service (e.g., a video streaming service). There may be one or more on-path network elements provisioned on a user plane network path associated with the application session. One issue is how to securely provide application metadata to one or more of the on-path network elements in the form of explicit signals.

### SUMMARY

Described herein are enhanced mechanisms to convey explicit signals to on-path network elements. In general, an application session is established between a UE and an application service via an Application Function (AF) of a 5G core network, and one or more on-path network elements are provisioned on a user plane network path between the UE and the application service, such as User Plane Functions (UPF) and/or RAN nodes. Pre-shared keying material, which is derived by or distributed to the UE, is also distributed to one or more of the on-path network elements. The pre-shared keying material may be used to encrypt application metadata in a transport protocol packet, such as a User Datagram Protocol (UDP) packet. When the transport protocol packet is received at an on-path network element, the on-path network element is able to decrypt the application metadata and perform an associated function based on the decrypted application metadata. One technical benefit is explicit signals may be sent to on-path network elements through the transport protocol.

In an embodiment (also referred to as an aspect), a method is described for sending application metadata to on-path network elements provisioned for an application session. The method comprises establishing the application session between an application client running on user equipment and an application service, identifying the application metadata associated with the application session, formatting a transport protocol packet with the application metadata, deriving an encryption key based on keying material, encrypting the application metadata in the transport protocol packet using the encryption key, and sending the transport protocol packet over a user plane network path comprising one or more of the on-path network elements.

In an embodiment, the deriving comprises deriving the encryption key from an authentication and key management for application key derived during primary authentication of the user equipment.

In an embodiment, the deriving comprises deriving the encryption key from hybrid public-key encryption keying material received from at least a 5G core network.

In an embodiment, the method further comprises determining, at a control plane network function of at least a 5G core network, whether the user equipment supports a metadata encryption scheme, identifying, when the user equipment supports the metadata encryption scheme, the on-path network elements provisioned on the user plane network path of the application session, identifying the keying material, and sending the keying material to the one or more of the on-path network elements.

In an embodiment, the method further comprises receiving, at the control plane network function, a support indicator from the user equipment during primary authentication indicating whether the user equipment supports the metadata encryption scheme.

In an embodiment, the identifying the on-path network elements comprises compiling a list of one or more user plane functions and/or one or more radio access network nodes on the user plane network path.

In an embodiment, the sending the keying material comprises pushing the keying material to a session management function, which in turn pushes the keying material to a user plane function on the user plane network path.

In an embodiment, the sending the keying material comprises pushing the keying material to an access and mobility management function, which in turn pushes the keying material to a radio access network node on the user plane network path.

In an embodiment, the method further comprises receiving, at one of the on-path network elements, the keying material sent by the control plane network function, receiving the transport protocol packet sent on the user plane network path, deriving a decryption key based on the keying material received from the control plane network function, decrypting the encrypted application metadata in the transport protocol packet using the decryption key, and performing a function associated with the application session based on the decrypted application metadata.

In an embodiment, the performing the function comprises applying a quality of service for the application session based on the decrypted application metadata.

In an embodiment, the transport protocol packet comprises a user datagram protocol packet, and the encrypted application metadata comprises a user datagram protocol option of the user datagram protocol packet.

In an embodiment, a 5G system is disclosed that supports sending of application metadata to on-path network elements provisioned for an application session. The 5G system comprises a means, at user equipment (UE), for establishing the application session between an application client running on the user equipment and an application service, a means for identifying the application metadata associated with the application session, a means for formatting a transport protocol packet with the application metadata, a means for deriving an encryption key based on keying material, a means for encrypting the application metadata in the transport protocol packet using the encryption key, and a means for sending the transport protocol packet over a user plane network path comprising one or more of the on-path network elements.

In an embodiment, the means for deriving comprises a means for deriving the encryption key from an authentication and key management for application key derived during primary authentication of the user equipment.

In an embodiment, the means for deriving comprises a means for deriving the encryption key from hybrid public-key encryption keying material received from at least a 5G core network.

In an embodiment, the 5G system further comprises a means for determining, at a control plane network function of at least a 5G core network, whether the user equipment supports a metadata encryption scheme, a means for identifying at the control plane network function, when the user equipment supports the metadata encryption scheme, the on-path network elements provisioned on the user plane network path of the application session, a means for identifying the keying material, and a means for sending the keying material to the one or more of the on-path network elements.

In an embodiment, the 5G system further comprises a means for receiving, at the control plane network function, a support indicator from the user equipment during primary authentication indicating whether the user equipment supports the metadata encryption scheme.

In an embodiment, the means for identifying the on-path network elements comprises a means for compiling a list of one or more user plane functions and/or one or more radio access network nodes on the user plane network path.

In an embodiment, the means for sending the keying material comprises a means for pushing the keying material to a session management function, which in turn pushes the keying material to a user plane function on the user plane network path.

In an embodiment, the means for sending the keying material comprises a means for pushing the keying material to an access and mobility management function, which in turn pushes the keying material to a radio access network node on the user plane network path.

In an embodiment, the 5G system further comprises a means for receiving, at one of the on-path network elements, the keying material sent by the control plane network function, a means for receiving, at the one of the on-path network elements, the transport protocol packet sent on the user plane network path, a means for deriving a decryption key based on the keying material received from the control plane network function, a means for decrypting the encrypted application metadata in the transport protocol packet using the decryption key, and a means for performing a function associated with the application session based on the decrypted application metadata.

In an embodiment, the means for performing the function comprises a means for applying a quality of service for the application session based on the decrypted application metadata.

In an embodiment, the transport protocol packet comprises a user datagram protocol packet, and the encrypted application metadata comprises a user datagram protocol option of the user datagram protocol packet.

Other embodiments may include computer readable media, other systems, or other methods as described below. Also, one or more embodiments as described above may be combinable as described herein.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a high-level architecture of a 5G system.

FIG. 2 illustrates a non-roaming architecture of a 5G system.

FIG. 3 is a signaling diagram that illustrates initiation of primary authentication.

FIG. 4 is a signaling diagram that illustrates an authentication procedure.

FIG. 5 illustrates a fundamental network model for AKMA.

FIG. 6 illustrates an AKMA architecture in reference point representation for internal AFs.

FIG. 7 illustrates an AKMA architecture in reference point representation for external AFs.

FIG. 8 is a signaling diagram that illustrates generating of the AKMA Anchor Key (K_{AKMA}) after primary authentication.

FIG. 9 is a signaling diagram that illustrates generating of the AKMA Application Key (K_{AF}).

FIG. 10 illustrates a UE accessing an external application service in an illustrative embodiment.

FIG. 11 illustrates an explicit signal sent over a user plane network path in an illustrative embodiment.

FIG. 12 is a block diagram of a UE in an illustrative embodiment.

FIG. 13 is a block diagram of a control plane network element in an illustrative embodiment.

FIG. 14 is a block diagram of a user plane network element in an illustrative embodiment.

FIG. 15 is a flow chart illustrating a method of encrypting application metadata in an illustrative embodiment.

FIG. 16 is a flow chart illustrating a method of disseminating keying material to one or more on-path network elements in an illustrative embodiment.

FIG. 17 is a flow chart illustrating a method of decrypting application metadata in an illustrative embodiment.

FIG. 18 illustrates a transport protocol packet in an illustrative embodiment.

FIG. 19 illustrates an IP packet in an illustrative embodiment.

FIG. 20 is a signaling diagram illustrating K_{AF}-based encryption in an illustrative embodiment.

FIG. 21 is a signaling diagram illustrating HPKE-based encryption in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

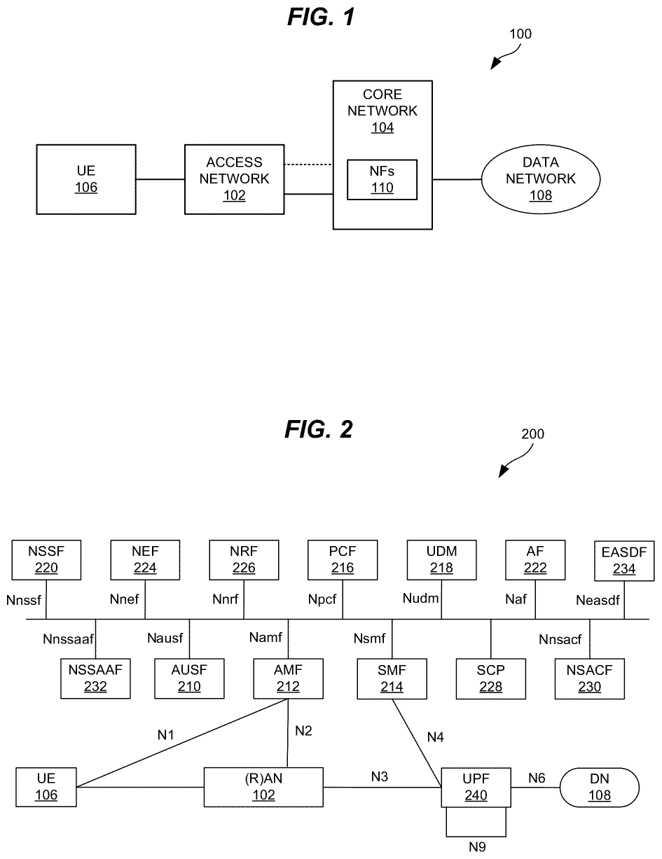

FIG. 1 illustrates a high-level architecture of a 5G system 100. A 5G system (5GS) 100 is a communication system (e.g., a 3GPP system) comprising a 5G Access Network ((R)AN) 102 and a 5G core network (5GC) 104 that communicates with 5G User Equipment (UE) 106. Although the term “5G” is used, any next generation networks beyond 5G are considered herein. Access network 102 provides radio or wireless connectivity to UE 106, and connects UE 106 to 5GC 104. Access network 102 may comprise a Next Generation Radio Access Network (NG-RAN), a non-3GPP access network, or another type of RAN connecting to 5GC 104. Access network 102 may support Evolved-UMTS Terrestrial Radio Access Network (E-UTRAN) access (e.g., through an eNodeB, gNodeB, and/or ng-eNodeB), Wireless Local Area Network (WLAN) access, fixed access, satellite radio access, new Radio Access Technologies (RAT), etc. 5GC 104 interconnects access network 102 with a data network (DN) 108. 5GC 104 is comprised of Network Functions (NF) 110, which may be implemented either as a network element on dedicated hardware, as a software instance running on dedicated hardware, as a virtualized function instantiated on an appropriate platform (e.g., a cloud infrastructure), etc. Data network 108 may be an operator external public or private data network, or an intra-operator data network (e.g., for IMS services). UE 106 (also referred to as a mobile terminal) includes a 5G capable device configured to register with 5GC 104 to access services. UE 106 may include an end user device, such as a mobile phone (e.g., smartphone), a tablet, a computer with a mobile broadband adapter, etc. UE 106 may be enabled for voice services, data services, Machine-to-Machine (M2M) or Machine Type Communications (MTC) services, and/or other services.

FIG. 2 illustrates a non-roaming architecture 200 of a 5G system. The architecture 200 in FIG. 2 is a service-based representation, as is further described in 3GPP TS 23.501 (v18.2.0), which is incorporated by reference as if fully included herein. Architecture 200 is comprised of Network Functions (NF) for a 5GC 104, and the NFs for the control plane (CP) are separated from the user plane (UP). The control plane of the 5GC 104 includes an Authentication Server Function (AUSF) 210, an Access and Mobility Management Function (AMF) 212, a Session Management Function (SMF) 214, a Policy Control Function (PCF) 216, a Unified Data Management (UDM) 218, a Network Slice Selection Function (NSSF) 220, and an Application Function (AF) 222. The control plane of the 5GC 104 further includes a Network Exposure Function (NEF) 224, a NF Repository Function (NRF) 226, a Service Communication Proxy (SCP) 228, a Network Slice Admission Control Function (NSACF) 230, a Network Slice-specific and SNPN Authentication and Authorization Function (NSSAAF) 232, and an Edge Application Server Discovery Function (EASDF) 234. The user plane of the 5GC 104 includes one or more User Plane Functions (UPF) 240 that communicate with data network 108. UE 106 is able to access the control plane and the user plane of the core network 104 through (R)AN 102.

There are a large number of subscribers that are able to access services from a carrier or home network operator that implements a mobile network comprising a 5G system 100, such as in FIGS. 1-2. Communications between the subscribers (i.e., through a UE) and the mobile network are protected by security mechanisms, such as the ones standardized by the 3GPP. Subscribers and the carrier expect security guarantees from the security mechanisms. One of the security mechanisms is the primary authentication procedure that provides mutual authentication between the UE and the network. The following further illustrates primary authentication.

The purpose of the primary authentication and key agreement procedures is to enable mutual authentication between UE 106 and the home network of the UE 106, and provide keying material that can be used between the UE 106 and the serving network in subsequent security procedures. The home network (e.g., Home Public Land Mobile Network (HPLMN)) represents an operator network or carrier network through which a subscriber (e.g., UE 106) has a subscription for services. The serving network has radio access equipment able to communicate with UE 106 via radio signals. The keying material generated by the primary authentication and key agreement procedure results in an anchor key (called the K_{SEAF} key) provided by the AUSF 210 of the home network to the Security Anchor Function (SEAF) of the serving network. The SEAF provides authentication functionality via the AMF 212 in the serving network, and supports primary authentication using a Subscription Concealed Identifier (SUCI) that contains the concealed Subscription Permanent Identifier (SUPI). The SUPI is a globally unique 5G identifier allocated to each subscriber in the 5G system 100. The SUCI is composed of a SUPI type, a Home Network Identifier (HN-ID) identifying the home network of the subscriber, a Routing Indicator (RID) that is assigned to the subscriber by the home network operator and provisioned in the Universal Subscriber Identity Module (USIM) of the UE, a Protection Scheme Identifier, a Home Network Public Key Identifier, and a Scheme Output. The anchor key (K_{SEAF}) is derived from an intermediate key called the K_{AUSF} key. The K_{AUSF} key is established between the UE 106 and the home network (AUSF 210) resulting from the primary authentication procedure.

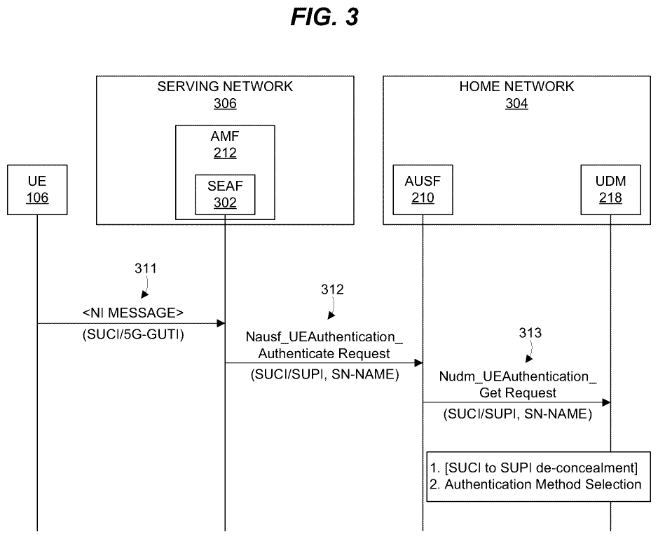

FIG. 3 is a signaling diagram that illustrates initiation of primary authentication, such as described in 3GPP TS 33.501 (v18.2.0), which is incorporated by reference as if fully included herein. UE 106 transmits an NI message 311 (i.e., an initial Non-Access Stratum (NAS) message) to the serving network 306 (e.g., the AMF 212 of the serving network 306), such as a Registration Request. The serving network 306 may also be referred to as a serving PLMN, or visited-PLMN (VPLMN) in a roaming scenario. UE 106 uses the SUCI or a 5G Global Unique Temporary Identifier (5G-GUTI) in the Registration Request. SEAF 302 of the AMF 212 may initiate an authentication with UE 106 during any procedure establishing a signaling connection with UE 106. SEAF 302 invokes the Nausf_UEAuthentication service toward the home network 304 (e.g., HPLMN) by sending a Nausf_UEAuthentication_Authenticate Request message 312 to AUSF 210 to initiate an authentication. The Nausf_UEAuthentication_Authenticate Request message 312 includes the SUCI or SUPI, and the serving network name (SN-Name). Upon receiving the Nausf_UEAuthentication_Authenticate Request message 312, AUSF 210 checks that the requesting SEAF 302 in the serving network 306 is entitled to use the serving network name (SNN) in the Nausf_UEAuthentication_Authenticate Request message 312 by comparing the serving network name with the expected serving network name. When the serving network 306 is authorized to use the serving network name, AUSF 210 sends a Nudm_UEAuthentication_Get Request message 313 to UDM 218 of the home network. The Nudm_UEAuthentication_Get Request message 313 includes the SUCI or SUPI, and the serving network name. Upon reception of the Nudm_UEAuthentication_Get Request message 313, UDM 218 identifies the SUPI (if received), or invokes a Subscription Identifier De-concealing Function (SIDF) that de-conceals the SUPI from the SUCI (if received). UDM 218 (or an Authentication credential Repository and Processing Function (ARPF) of UDM 218) selects or chooses the authentication method for primary authentication based on the SUPI.

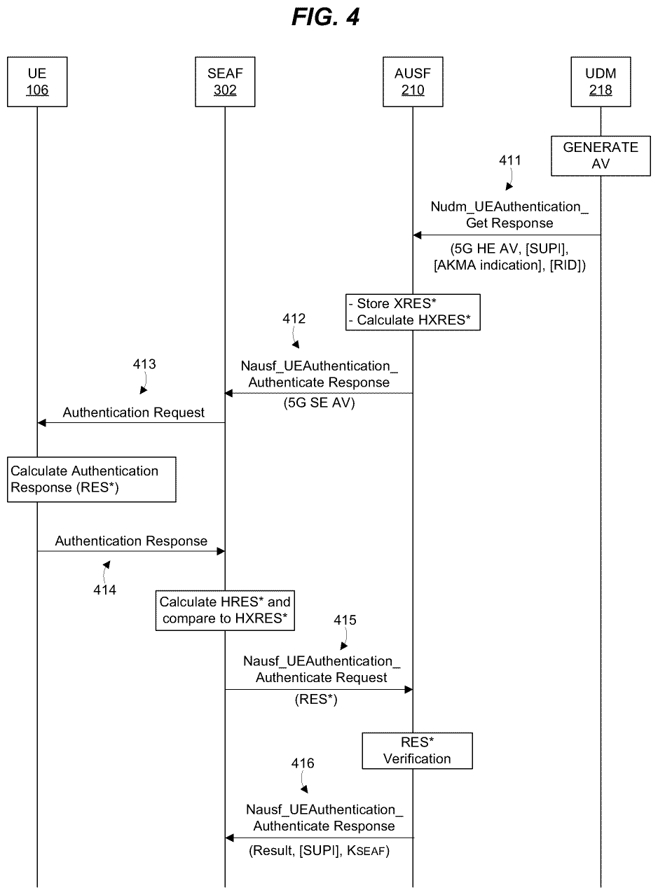

FIG. 4 is a signaling diagram that illustrates a primary authentication procedure, such as described in 3GPP TS 33.501. In this example, 5G Authentication and Key Agreement (AKA) is described, but similar concepts apply for Extensible Authentication Protocol AKA prime (EAP-AKA′). For a Nudm_UEAuthentication_Get Request, UDM 218 creates a 5G Home Environment Authentication Vector (5G HE AV) for the selected authentication method. UDM 218 derives the K_{AUSF} key and calculates an expected response (XRES*) to a challenge. UDM 218 creates the 5G HE AV comprising an authentication token (AUTN), the expected response (XRES*), the K_{AUSF} key, and a random challenge (RAND). UDM 218 then sends a Nudm_UEAuthentication_Get Response message 411 to AUSF 210 with the 5G HE AV to be used for authentication (e.g., 5G AKA in FIG. 4). In case the SUCI was included in the Nudm_UEAuthentication_Get Request, UDM 218 includes the SUPI in the Nudm_UEAuthentication_Get Response message 411 after de-concealment of the SUPI from the SUCI. If a subscriber has an Authentication and Key Management for Application (AKMA) subscription, UDM 218 may include an AKMA indication and the RID in the Nudm_UEAuthentication_Get Response message 411.

In response to the Nudm_UEAuthentication_Get Response message 411, AUSF 210 stores the expected response (XRES*) temporarily with the received SUCI or SUPI. AUSF 210 then generates a 5G Authentication Vector (5G AV) from the 5G HE AV received from UDM 218, by computing a hash expected response (HXRES*) from the expected response (XRES*) and the K_{SEAF} key from the K_{AUSF} key, and replacing the XRES* with the HXRES* and the K_{AUSF} key with the K_{SEAF} key in the 5G HE AV. AUSF 210 removes the K_{SEAF} key to generate a 5G Serving Environment Authentication Vector (5G SE AV) that includes the authentication token (AUTN), hash expected response (HXRES*), and the random challenge (RAND). AUSF 210 sends a Nausf_UEAuthentication_Authenticate Response message 412 to SEAF 302 that includes the 5G SE AV. In response, SEAF 302 sends the authentication token (AUTN) and the random challenge (RAND) to UE 106 in a NAS message Authentication Request message 413.

Although not shown in FIG. 4, UE 106 includes Mobile Equipment (ME) and a USIM. The ME receives the authentication token (AUTN) and the random challenge (RAND) in the NAS message Authentication Request message 413, and forwards the authentication token (AUTN) and the random challenge (RAND) to the USIM. The USIM of UE 106 verifies the freshness of the received values by checking whether the authentication token (AUTN) can be accepted. If so, the USIM computes a response (RES), a cipher key (CK), and an integrity key (IK) based on the random challenge (RAND), and returns the response (RES), the CK key, and the IK key to the ME. The ME of UE 106 computes RES* from RES, and calculates the K_{AUSF} key from CK∥IK and the K_{SEAF} key from the K_{AUSF} key.

UE 106 sends a NAS message Authentication Response message 414 to SEAF 302 that includes RES*. In response, SEAF 302 computes HRES* from RES*, and compares HRES* and HXRES*. If they coincide, SEAF 302 considers the authentication successful from the serving network point of view. SEAF 302 sends RES*, as received from UE 106, in a Nausf_UEAuthentication_Authenticate Request message 415 to AUSF 210. When AUSF 210 receives the Nausf_UEAuthentication_Authenticate Request message 415 including a RES* as authentication confirmation, AUSF 210 stores the K_{AUSF} key based on the home network operator's policy, and compares the received RES* with the stored XRES*. If the RES* and XRES* are equal, then AUSF 210 considers the authentication successful from the home network point of view. AUSF 210 informs UDM 218 about the authentication result (not shown). AUSF 210 also sends a Nausf_UEAuthentication_Authenticate Response message 416 to SEAF 302 indicating whether or not the authentication was successful from the home network point of view. If the authentication was successful, the K_{SEAF} key is sent to SEAF 302 in the Nausf_UEAuthentication_Authenticate Response message 416. In case AUSF 210 received the SUCI from SEAF 302 in the authentication request, AUSF 210 includes the SUPI in the Nausf_UEAuthentication_Authenticate Response message 416 if the authentication was successful.

AKMA (Authentication and Key Management for Application) is a feature that leverages an operator authentication infrastructure to secure communications between a UE 106 and an AF 222. AKMA is described in 3GPP TS 33.535 (v18.0.0), which is incorporated by reference as if fully included herein. An Application Function (AF) is a control plane function within a 5G core network that provides application services to a subscriber (e.g., an NF service consumer). An application service as described herein refers to a type of computer-based service provided using one or more networks. Examples of an application service include data streaming (i.e., video, audio, etc.), voice and/or video calls, social media, online gaming, etc.

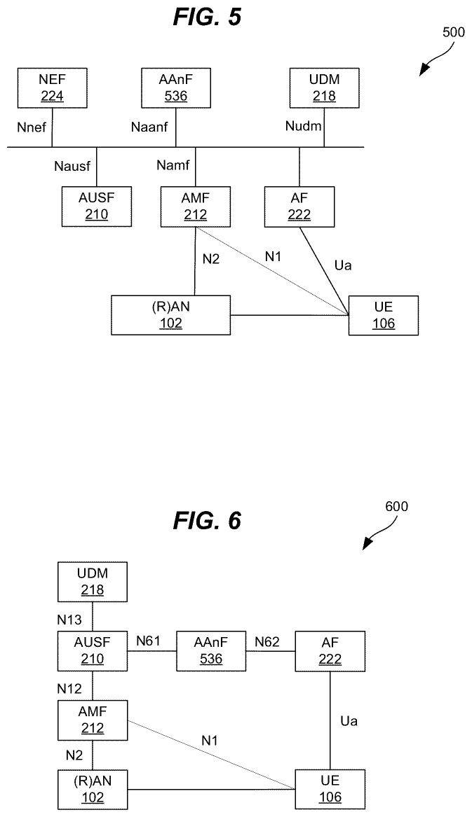

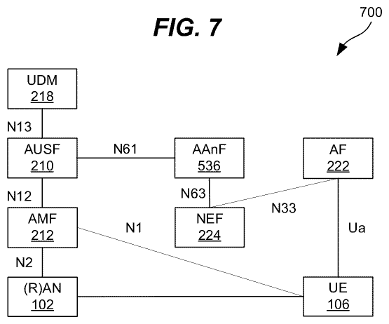

FIG. 5 illustrates a fundamental network model 500 for AKMA. FIG. 6 illustrates an AKMA architecture 600 in reference point representation for internal AFs (i.e., AFs located inside the operator's network). FIG. 7 illustrates an AKMA architecture 700 in reference point representation for external AFs (i.e., AFs located outside the operator's network).

In FIG. 5, network model 500 for AKMA includes AUSF 210, AMF 212, UDM 218, AF 222, and NEF 224. Network model 500 for AKMA also includes an AKMA Anchor Function (AAnF) 536, which is the anchor function in the HPLMN. AAnF 536 stores the AKMA Anchor Key (K_{AKMA}) and the SUPI for the AKMA service, which is received from AUSF 210 after the UE 106 completes a successful 5G primary authentication. AAnF 536 also generates the key material to be used between the UE 106 and AF 222, and maintains UE AKMA contexts. AAnF 536 sends the SUPI of UE 106 to AF 222 located inside the operator's network, or to NEF 224. An AKMA AF 222 requests an AKMA Application Key, called K_{AF}, from AAnF 536 using an AKMA Key Identifier (A-KID).

AKMA reuses the 5G primary authentication procedure to authenticate a UE 106. As an overview, successful 5G primary authentication results in the K_{AUSF} key being stored at AUSF 210 and UE 106. After UE 106 finishes primary authentication and before it initiates communication with an AF 222, UE 106 generates the K_{AKMA} key and the A-KID from the K_{AUSF} key. After receiving the K_{AUSF} key from UDM 218, AUSF 210 stores the K_{AUSF} key, and generates the K_{AKMA} key and the A-KID from the K_{AUSF} key. AUSF 210 sends the K_{AKMA} key and the A-KID along with the SUPI of UE 106 to AAnF 536, which stores the K_{AKMA} key.

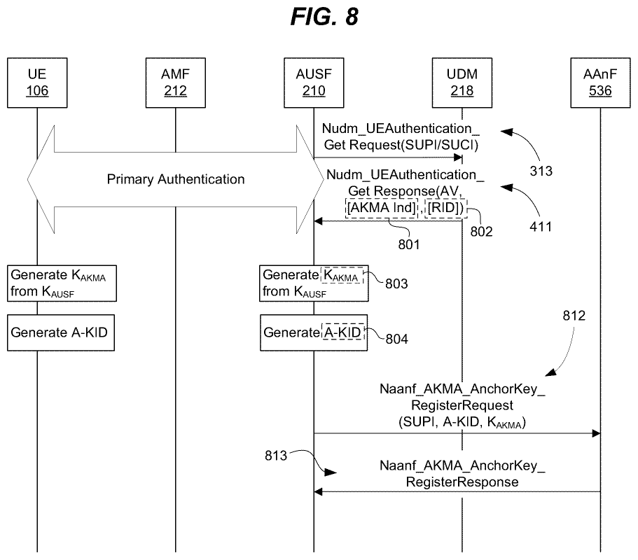

Further details of an AKMA procedure are described below. FIG. 8 is a signaling diagram that illustrates generating of the AKMA Anchor Key (K_{AKMA}) after primary authentication. During the primary authentication procedure, AUSF 210 interacts with UDM 218 in order to fetch authentication information, such as subscription credentials (e.g., AKA Authentication vectors) and the authentication method using the Nudm_UEAuthentication_Get Request service operation (i.e., sending a Nudm_UEAuthentication_Get Request message 313 to UDM 218). In the response, UDM 218 may also provide an AKMA indication 801 to AUSF 210 whether the K_{AKMA} key 803 needs to be generated for UE 106 (i.e., if UE 106 supports AKMA). If the AKMA indication 801 is included, UDM 218 also includes the RID 802 of UE 106 in the Nudm_UEAuthentication_Get Response 411.

If AUSF 210 receives the AKMA indication 801 from UDM 218, AUSF 210 stores the K_{AUSF} key, and generates the K_{AKMA} key 803 and the A-KID 804 from the K_{AUSF} key after the primary authentication procedure is successfully completed. Likewise, UE 106 generates the K_{AKMA} key 803 and the A-KID 804 from the K_{AUSF} key before initiating communication with an AKMA AF 222. After the AKMA key material is generated, AUSF 210 selects the AAnF 536 and sends the A-KID 804 and the K_{AKMA} key 803 to AAnF 536 along with the SUPI of UE 106 using an Naanf_AKMA_AnchorKey_Register Request message 812. AAnF 536 sends a response to AUSF 210 using an Naanf_AKMA_AnchorKey_Register Response message 813.

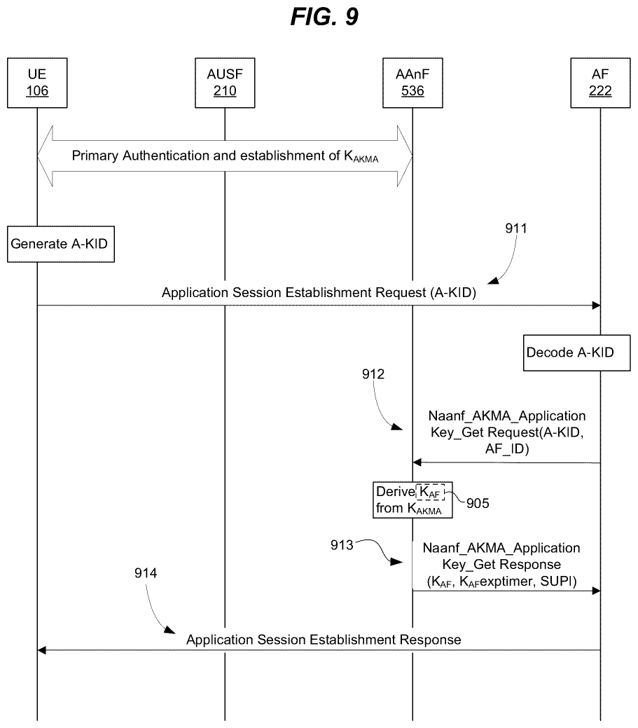

FIG. 9 is a signaling diagram that illustrates generating of the AKMA Application Key (K_{AF}). Before communication between UE 106 and the AKMA AF 222 can begin, UE 106 and the AKMA AF 222 need to know whether to use the AKMA service. This knowledge is implicit to the specific application on UE 106 and AKMA AF 222 or indicated by the AKMA AF 222 to UE 106. UE 106 generates the K_{AKMA} key 803 and the A-KID 804 from the K_{AUSF} key before initiating communication with an AKMA AF 222. When UE 106 initiates communication with the AKMA AF 222, UE 106 includes the A-KID 804 in a session request to the AKMA AF 222 (e.g., the Application Session Establishment Request message 911). UE 106 may derive the K_{AF} key from the K_{AKMA} key 803 (e.g., Annex A.4 of 3GPP TS 33.535) before sending the session request or afterwards.

If the AKMA AF 222 does not have an active context associated with the A-KID 804, then the AKMA AF 222 selects an AAnF 536 based on the A-KID 804. The AKMA AF 222 then sends a Naanf_AKMA_ApplicationKey_Get request message 912 to AAnF 536 with the A-KID 804 to request the K_{AF} key for UE 106. AKMA AF 222 also includes its identity (AF_ID) in the request.

AAnF 536 checks whether it can provide the AKMA service to the AKMA AF 222 based on the configured local policy or based on the authorization information available in the signaling. If it succeeds, then the following procedures are executed. Otherwise, AAnF 536 rejects the procedure. AAnF 536 verifies whether the subscriber is authorized to use AKMA based on the presence of the UE-specific K_{AKMA} key 803 identified by the A-KID 804. AAnF 536 derives the Application Function (AF) key (i.e., K_{AF} key 905) from the K_{AKMA} key 803 if it does not already have the K_{AF} key 905, and sends an Naanf_AKMA_ApplicationKey_Get response message 913 to AKMA AF 222 with the SUPI, the K_{AF} key 905, and a K_{AF} expiration time. AKMA AF 222 sends an AKMA response (e.g., the Application Session Establishment Response message 914) to UE 106.

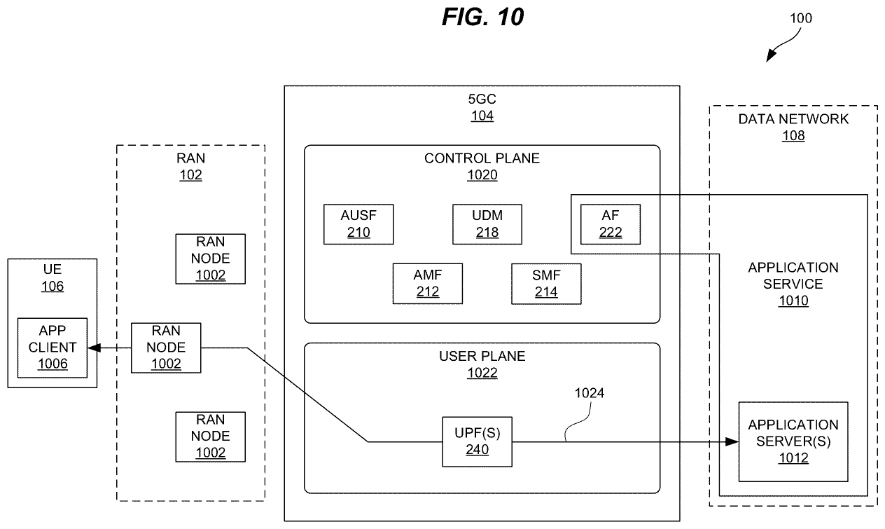

To access an application service, such as an application service associated with an AF 222, a UE 106 may host an application client. FIG. 10 illustrates a UE 106 accessing an external application service in an illustrative embodiment. In this example, 5G system 100 includes a RAN 102 and a 5GC 104 as discussed above. RAN 102 includes one or more RAN nodes 1002, which are equipment, hardware, means, etc., of a RAN 102 that serves a UE 106 (e.g., a gNB, a gNB-CU, a gNB-DU, and/or another type of node implemented in a RAN). As described above, Network Functions (NF) for 5GC 104 are separated into the control plane (CP) 1020 and the user plane (UP) 1022. The control plane 1020 includes AUSF 210, AMF 212, SMF 214, UDM 218, and AF 222. The user plane 1022 includes one or more UPFs 240. UE 106 is able to access the control plane 1020 and the user plane 1022 through RAN 102.

In this example, an application service 1010 (also referred to as a third-party application service) is implemented in a data network 108, such as by an Application Service Provider (ASP), and is accessible to UE 106 through the 5G system 100. An ASP is an entity (including physical or virtual resources) that offers users or subscribers access to applications and related services over one or more networks. Examples of application service 1010 offered by an ASP include, but are not limited to, gaming, Augmented reality (AR) and/or Virtual Reality (VR), audio or video streaming (e.g., of mass events such as concerts, sport tournaments, etc.), network-assisted control of autonomously guided vehicles (AGV), network-assisted control of mobile robots in a factory, etc. In this example, the application service 1010 is provided or implemented on one or more application servers 1012.

AF 222 provides control plane functionality for an application session between the application service 1010 and a UE 106. If AF 222 is trusted, AF 222 may interact directly with NFs of 5GC 104. If AF 222 is a third party, then AF 222 interacts with an NEF 224. UE 106 hosts an application client 1006, which is an application (e.g., stand-alone application), component, executable code, means, etc., that runs on UE 106, and is configured to access an application service 1010. For example, application client 1006 interacts with control plane NFs (e.g., AF 222) to establish an application session with the application service 1010. With the application session established, data may be exchanged between the application client 1006 and the application service 1010 over the user plane 1022 through one or more RAN nodes 1002 and one or more UPFs 240. For example, data in the form of packets may be sent from the application client 1006 to the application service 1010, and/or from the application service 1010 to the application client 1006 over a user plane network path 1024.

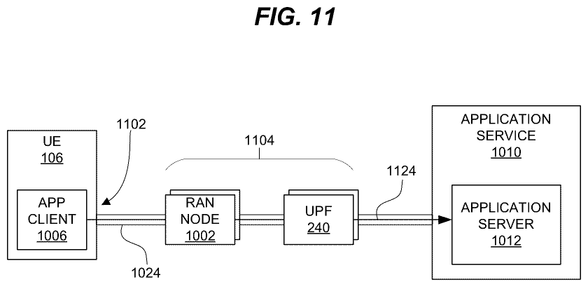

In an embodiment, there are many cases where elements (e.g., RAN nodes 1002 and/or UPFs 240) on the user plane network path 1024 can provide beneficial services. For example, RFC 8558 of the Internet Engineering Task Force (IETF) defines “path signals” as endpoint signals to or from on-path network elements. The path signals used to often be implicit, (e.g., derived from cleartext end-to-end information by examining transport protocols). For example, the state machine described for Transmission Control Protocol (TCP) as in RFC 9293 uses a set of well-known control messages that are exchanged in the clear. Because these messages are visible to network elements on the path between the nodes that are setting up a transport connection, they are often used as signals by those network elements for various purposes. The path signals may also be encrypted by the endpoints, which may be referred to as explicit signals. FIG. 11 illustrates an explicit signal 1124 sent over a user plane network path 1024 in an illustrative embodiment. In this embodiment, application client 1006 sends an explicit signal 1124 to application server 1012. Thus, application client 1006 represents an endpoint 1102, and RAN node 1002 and UPF 240 represent on-path network elements 1104 on user plane network path 1024.

Described herein are mechanisms to convey explicit signals 1124 to on-path network elements 1104 that prevent pervasive monitoring, and ensure that explicit signal dissemination is limited to the intended on-path network elements 1104. In general, the mechanisms are implemented via one or more 5G network functions, one or more on-path network elements 1104, and a UE 106. Block diagrams of these elements are provided below.

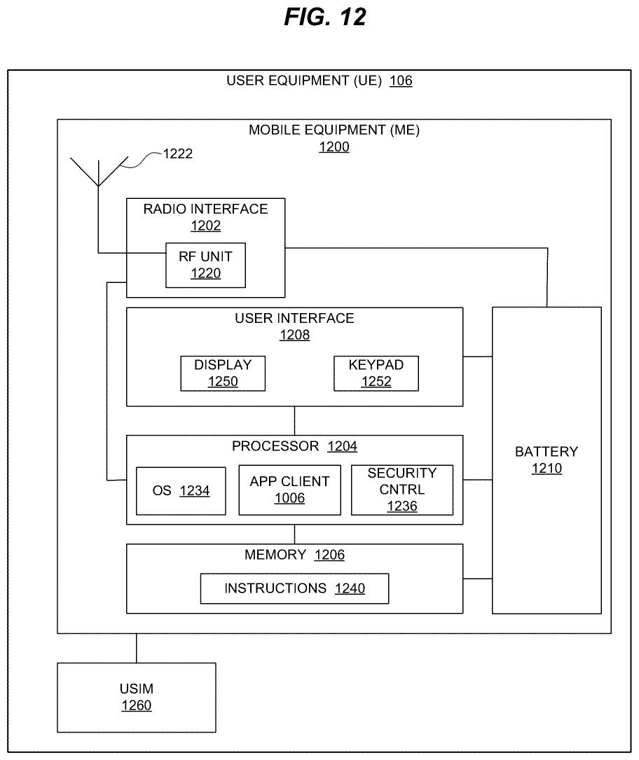

FIG. 12 is a block diagram of a UE 106 in an illustrative embodiment. From a functional standpoint, UE 106 is composed of at least two parts: Mobile Equipment (ME) 1200 and a Universal Subscriber Identity Module (USIM) 1260. ME 1200 includes a radio interface component 1202, one or more processors 1204, a memory 1206, a user interface component 1208. UE 106 may also comprise a battery 1210. Radio interface component 1202 is a hardware component or means that represents the local radio resources of UE 106, such as an RF unit 1220 (e.g., one or more radio transceivers) and one or more antennas 1222. Radio interface component 1202 may be configured for WiFi, Bluetooth, 5G NR, LTE, etc. Processor 1204 represents the internal circuitry, logic, hardware, means, etc., that provides the functions of UE 106. Processor 1204 may be configured to execute instructions 1240 for software that are loaded into memory 1206. Processor 1204 may execute an Operating System (OS) 1234 for UE 106 that manages hardware and software resources, and one or more application clients 1006. Processor 1204 may also execute a security controller 1236, which comprises a component or means for controlling application sessions of an application client 1006. User interface component 1208 is a hardware component for interacting with an end user. For example, user interface component 1208 may include a display 1250, screen, touch screen, or the like (e.g., a Liquid Crystal Display (LCD), a Light Emitting Diode (LED) display, etc.). User interface component 1208 may include a keyboard or keypad 1252, a tracking device (e.g., a trackball or trackpad), a speaker, a microphone, etc.

USIM 1260 is an integrated circuit that provides security and integrity functions for UE 106. USIM 1260 includes or is provisioned with a subscription profile associated with a subscription of a subscriber. A subscription profile may include a variety of information, such as subscription credentials (e.g., SUPI) used to uniquely identify a subscription and to mutually authenticate the UE 106 and a network.

UE 106 may include various other components not specifically illustrated in FIG. 12.

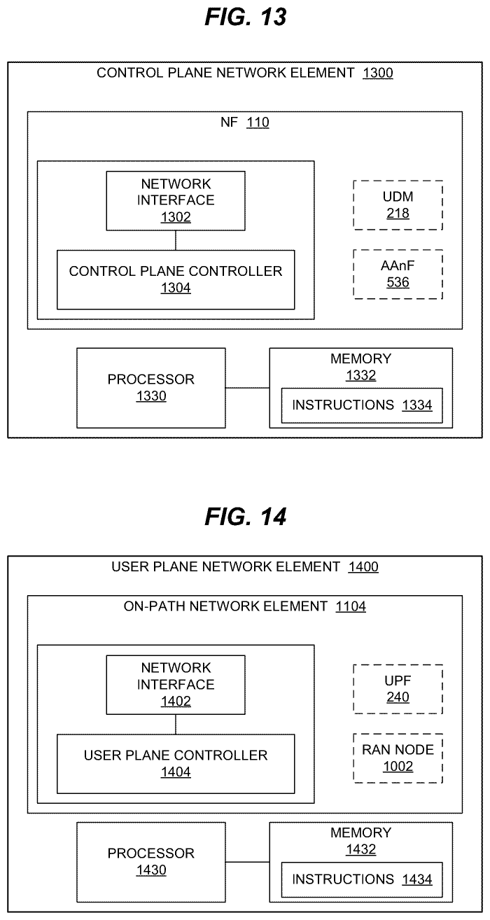

FIG. 13 is a block diagram of a control plane network element 1300 in an illustrative embodiment. Control plane network element 1300 comprises a server, device, apparatus, equipment (including hardware), system, means, etc., configured to implement one or more NFs 110 in the control plane 1020 of a 5G core network 104. In this embodiment, control plane network element 1300 includes the following subsystems: a network interface component 1302, and a control plane controller 1304 that operate on one or more platforms. Network interface component 1302 may comprise circuitry, logic, hardware, means, etc., configured to exchange control plane messages or signaling with other network elements, network functions, and/or UEs. Network interface component 1302 may operate using a variety of protocols or reference points. Control plane controller 1304 may comprise circuitry, logic, hardware, means, etc., configured to support operations or procedures performed in the control plane 1020 of a 5G system 100. As illustrated in FIG. 13, control plane network element 1300 may represent a UDM 218, an AAnF 536, and/or another type of NF in the control plane 1020 of a 5G core network 104 as discussed above.

One or more of the subsystems of control plane network element 1300 may be implemented on a hardware platform comprised of analog and/or digital circuitry. One or more of the subsystems of control plane network element 1300 may be implemented on one or more processors 1330 that execute instructions 1334 (i.e., computer readable code) for software that are loaded into memory 1332. A processor 1330 comprises an integrated hardware circuit configured to execute instructions 1334 to provide the functions of control plane network element 1300. Processor 1330 may comprise a set of one or more processors or may comprise a multi-processor core, depending on the particular implementation. Memory 1332 is a non-transitory computer readable storage medium for data, instructions, applications, etc., and is accessible by processor 1330. Memory 1332 is a hardware storage device capable of storing information on a temporary basis and/or a permanent basis. Memory 1332 may comprise a random-access memory, or any other volatile or non-volatile storage device.

Control plane network element 1300 may include various other components not specifically illustrated in FIG. 13.

FIG. 14 is a block diagram of a user plane network element 1400 in an illustrative embodiment. User plane network element 1400 comprises a server, device, apparatus, equipment (including hardware), system, means, etc., configured to handle traffic in the user plane 1022 of a 5G core network 104 and/or RAN 102. User plane network element 1400 is an example of an on-path network element 1104 as shown in FIG. 11. In this embodiment, user plane network element 1400 includes the following subsystems: a network interface component 1402, and a user plane controller 1404 that operate on one or more platforms. Network interface component 1402 may comprise circuitry, logic, hardware, means, etc., configured to exchange user plane messages or packets with other network elements, network functions, RAN elements, and/or UEs. Network interface component 1402 may operate using a variety of protocols. User plane controller 1404 may comprise circuitry, logic, hardware, means, etc., configured to support operations or procedures performed in the user plane 1022 of a 5G system 100. As illustrated in FIG. 14, user plane network element 1400 may represent a UPF 240, a RAN node 1002, and/or another type of NF or element in the user plane 1022 of a 5G system 100 as discussed above.

One or more of the subsystems of user plane network element 1400 may be implemented on a hardware platform comprised of analog and/or digital circuitry. One or more of the subsystems of user plane network element 1400 may be implemented on one or more processors 1430 that execute instructions 1434 (i.e., computer readable code) for software that are loaded into memory 1432. A processor 1430 comprises an integrated hardware circuit configured to execute instructions 1434 to provide the functions of user plane network element 1400. Processor 1430 may comprise a set of one or more processors or may comprise a multi-processor core, depending on the particular implementation. Memory 1432 is a non-transitory computer readable storage medium for data, instructions, applications, etc., and is accessible by processor 1430. Memory 1432 is a hardware storage device capable of storing information on a temporary basis and/or a permanent basis. Memory 1432 may comprise a random-access memory, or any other volatile or non-volatile storage device.

User plane network element 1400 may include various other components not specifically illustrated in FIG. 14.

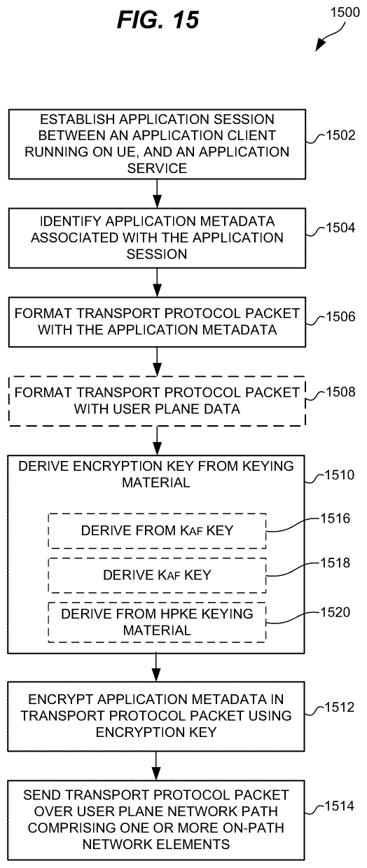

FIGS. 15-17 are flow charts illustrating a method of sending an explicit signal (i.e., encrypted application metadata) to on-path network elements 1104 provisioned for an application session in an illustrative embodiment. FIG. 15 is a flow chart illustrating a method 1500 of encrypting application metadata in an illustrative embodiment. The steps of method 1500 are described as being performed in a UE 106, but the steps of method 1500 may be performed in other entities, such as an application service 1010 (e.g., AF 222 or application server 1012). The steps of the flow charts described herein are not all inclusive and may include other steps not shown, and the steps may be performed in an alternative order.

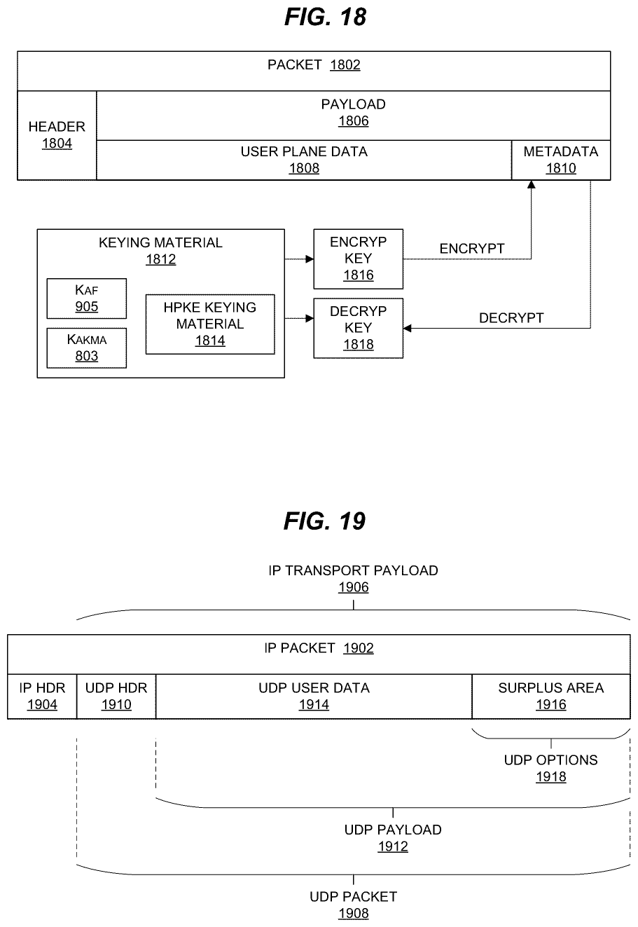

UE 106 (such as shown in FIG. 12) communicates with an AF 222 of the 5GC 104 to establish an application session between the application client 1006 running on UE 106, and an application service 1010 (step 1502). For example, UE 106 may send an application session request message toward AF 222 to establish the application session, or AF 222 may send the application session request message toward UE 106. With the application session established, UE 106 formats a transport protocol packet for the application session. FIG. 18 illustrates a transport protocol packet 1802 in an illustrative embodiment. The general structure of transport protocol packet 1802 includes a packet header 1804 and a payload 1806.

In FIG. 15, UE 106 identifies application metadata associated with the application session (step 1504). Application metadata comprises data that summarizes application traffic at a higher, abstracted level (i.e., above the transport layer). Application metadata provides greater visibility into how applications are performing, behaving, and being used across a user plane network path 1024. For example, application metadata may specify or request Quality of Service (QOS) details for the application session. In another example, application metadata may provide security details for an application session. However, application metadata as described herein may be used to control or define other aspects of an application session to on-path network elements 1104.

UE 106 formats the transport protocol packet 1802 with the application metadata (step 1506). In other words, UE 106 inserts the application metadata 1810 in the payload 1806 of the transport protocol packet 1802 as in FIG. 18. UE 106 may also identify user plane data 1808 for the application session. User plane data 1808 comprises any data that application client 1006 wants to exchange with the application service 1010. UE 106 may further format the transport protocol packet 1802 with the user plane data 1808 (optional step 1508 of FIG. 15). In other words, UE 106 may insert the user plane data 1808 for the application session into the payload 1806 of the transport protocol packet 1802.

In FIG. 15, UE 106 derives an encryption key based on keying material (step 1510). Keying material comprises data used to form a secret encryption and/or decryption key. UE 106 may include an algorithm (e.g., in security controller 1236) configured to derive the encryption key from the keying material. As in FIG. 18, UE 106 derives encryption key 1816 based on keying material 1812, which is also shared with the on-path network elements 1104. In an embodiment, UE 106 may derive the encryption key 1816 based on keying material 1812 received during primary authentication, such as AKMA keying material. For example, a UE 106 enabled for AKMA, as described in FIG. 9, derives the K_{AF} key 905 before sending the session request or afterwards. As shown in FIG. 18, the keying material 1812 may comprise the K_{AF} key 905 derived during AKMA procedures, and UE 106 may derive the encryption key 1816 based on the K_{AF} key 905 (optional step 1516). In another example, the K_{AF} key 905 may comprise the encryption key 1816, and the keying material 1812 may comprise the K_{AKMA} key 803 used to derive the K_{AF} key 905 (optional step 1518). One technical benefit is the K_{AF} key 905 may be reused to protect the application metadata.

In an embodiment, UE 106 may receive the keying material 1812 from the 5GC 104, such as after primary authentication. For example, a UE 106 may use a Hybrid Public-Key Encryption (HPKE) scheme as in RFC 9180 to encrypt the application metadata 1810. HPKE is a scheme that provides public key encryption of arbitrary-sized plaintexts given a recipient's public key. HPKE utilizes a non-interactive ephemeral-static Diffie-Hellman exchange to establish a shared secret. HPKE requires the endpoint to be securely provisioned with the HPKE key configuration (Key Identifier, KEM ID, HPKE Ephemeral Public Key (pKE), and HPKE Symmetric Algorithms). Thus, the keying material 1812 may comprise HPKE keying material 1814, and UE 106 may derive the encryption key 1816 based on the HPKE keying material 1814 (optional step 1520). One technical benefit is HPKE may be used to protect the application metadata.

UE 106 encrypts the application metadata 1810 in the transport protocol packet 1802 using the encryption key 1816 (step 1512). UE 106 sends the transport protocol packet 1802 over the user plane network path 1024 comprising one or more on-path network elements 1104 (step 1514). It is understood that the transport protocol packet 1802 may be packaged in a higher-level packet, such as Internet Protocol (IP) when sent over the user plane network path 1024. One technical benefit is application metadata 1810 may be securely sent over the user plane network path 1024 via encryption at the transport layer.

Although the method of FIG. 15 was described with respect to UE 106, it is noted that an AF 222 may operate in a similar manner to encrypt metadata associated with an application session.

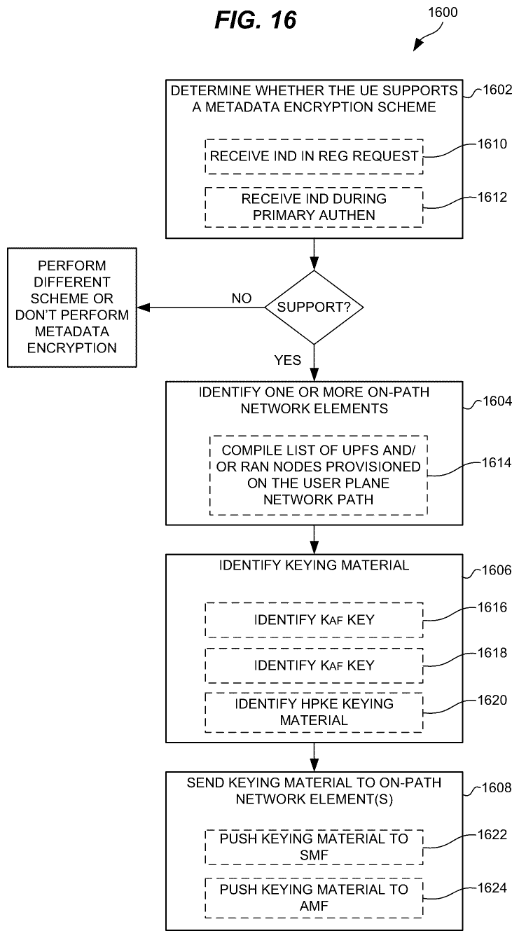

FIG. 16 is a flow chart illustrating a method 1600 of disseminating the keying material 1812 to one or more on-path network elements 1104 in an illustrative embodiment. When an application session is established between the application client 1006 of UE 106 and the application service 1010, a control plane NF 110 (such as shown in FIG. 13) of the 5GC 104 determines whether the UE 106 supports a metadata encryption scheme (step 1602). For example, control plane NF 110 may receive an indicator (referred to as a support indicator) from UE 106 indicating whether UE 106 supports the metadata encryption scheme, such as in a registration request to an AMF 212 (optional step 1610), during primary authentication of the UE 106 (optional step 1612), etc. One technical benefit is the UE 106 may report its capabilities to the 5GC 104 regarding metadata encryption.

When the UE 106 supports the metadata encryption scheme, control plane NF 110 identifies one or more on-path network elements 1104 provisioned on the user plane network path 1024 of the application session (step 1604). For example, control plane NF 110 may compile a list of one or more UPFs 240 and/or one or more RAN nodes 1002 provisioned on the user plane network path 1024 (optional step 1614). One technical benefit is each on-path network element 1104 may be effectively identified by the control plane NF 110.

Control plane NF 110 identifies the keying material 1812 associated with the application session (step 1606). As above, control plane NF 110 may identify an AKMA key (e.g., the K_{AF} key 905 (optional step 1616) or the K_{AKMA} key 803 (optional step 1618)), or the HPKE keying material 1814 (optional step 1620) as the keying material 1812. Control plane NF 110 then sends, disseminates, or otherwise distributes the keying material 1812 to one or more of the on-path network elements 1104 (step 1608). For example, control plane NF 110 may push the keying material 1812 to an SMF 214, which in turn pushes the keying material 1812 to a UPF 240 (optional step 1622). One technical benefit is the control plane NF 110 is able to effectively distribute the keying material 1812 to any on-path UPFs. Control plane NF 110 may push the keying material 1812 to an AMF 212, which in turn pushes the keying material 1812 to a RAN node 1002 (optional step 1624). One technical benefit is the keying material 1812 is effectively distributed to any on-path UPFs and/or RAN nodes 1002 to decipher explicit signals sent over the transport layer.

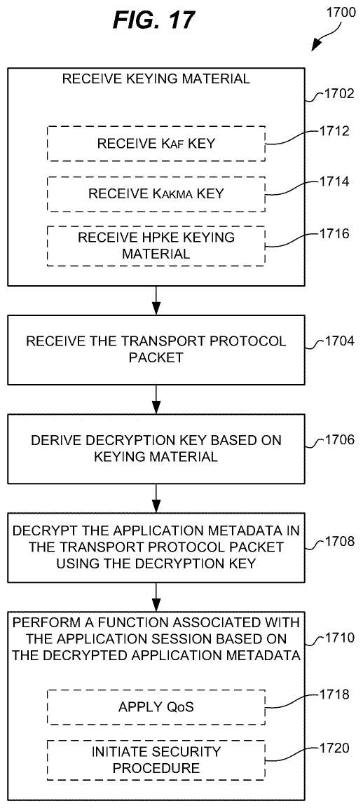

FIG. 17 is a flow chart illustrating a method 1700 of decrypting application metadata 1810 in an illustrative embodiment. An on-path network element 1104 (such as shown in FIG. 14) receives the keying material 1812 sent by control plane NF 110 (step 1702). As above, on-path network element 1104 may receive an AKMA key (e.g., the K_{AF} key 905 (optional step 1712) or the K_{AKMA} key 803 (optional step 1714)), or the HPKE keying material 1814 (optional step 1716) as the keying material 1812. On-path network element 1104 receives the transport protocol packet 1802 sent on the user plane network path 1024 (step 1704), with the encrypted application metadata 1810. On-path network element 1104 derives a decryption key based on keying material 1812 (step 1706). On-path network element 1104 may include an algorithm configured to derive the decryption key from the keying material 1812. As in FIG. 18, UE 106 derives decryption key 1818 based on keying material 1812. On-path network element 1104 decrypts the encrypted application metadata 1810 in the transport protocol packet 1802 using the decryption key 1818 (step 1708). On-path network element 1104 then performs a function or action associated with the application session based on the decrypted application metadata 1810 (step 1710). For example, on-path network element 1104 may apply a Quality of Service (QOS) for the application session based on the application metadata 1810 (optional step 1718). In another example, on-path network element 1104 may initiate or configure a security procedure based on the application metadata 1810 (optional step 1720), such as to close a UDP pin-hole in a firewall after a flow for the application session is terminated to prevent incoming attack packets. However, on-path network element 1104 may perform other functions, actions, or operations, or otherwise adjust configurations of the application session based on the application metadata 1810 extracted from the transport protocol packet 1802. One technical benefit is differentiated network services may be applied to application sessions using explicit signals sent via the transport layer.

Other on-path network elements 1104 or a UE 106 may operate in a similar fashion in response to receiving the transport protocol packet 1802. One technical benefit is any on-path network elements 1104 is able to decipher explicit signals in a transport protocol packet 1802.

In an embodiment, the application metadata 1810 may be inserted in the “options” portion of a User Datagram Protocol (UDP) datagram (also referred to as a UDP packet). In general, the Open Systems Interconnection (OSI) model is a conceptual framework used to describe the functions of a networking system. The OSI model divides the tasks involved with moving information between networked computers into seven task groups or layers, which are the physical layer, the data link layer, the network layer, and transport layer, the session layer, the presentation layer, and the application layer. Tasks of the transport layer include error correction, segmenting/de-segmenting data, flow control, etc. For example, the send side of the transport layer divides application messages into segments (e.g., packets) and passes segments to the network layer. The receiving side reassembles the segments into application messages, and passes the application messages to the application layer. The transport layer uses Transmission Control Protocol (TCP) and UDP to carry out its tasks.

UDP is part of the Internet Protocol (IP) suite used by programs running on different computers on a network. UDP is used to send short messages called datagrams. UDP uses a simple transmission model but does not employ handshaking dialogs for reliability, ordering, and data integrity. The protocol assumes that error-checking and correction is not required, thus avoiding processing at the network interface level. FIG. 19 illustrates an IP packet 1902 in an illustrative embodiment. IP packet 1902 includes an IP header 1904 and an IP transport payload 1906. UDP operates on top of IP, so a UDP packet 1908 is carried in the IP transport payload 1906. UDP packet 1908 has the structure of a UDP header 1910 and a UDP payload 1912. The first eight bytes of a UDP packet 1908 contain the UDP header 1910, while the remaining bytes contain the UDP payload 1912. A UDP header 1910 contains four fields of two bytes each: source port number, destination port number, datagram size (i.e., length field), and a checksum. The UDP length field may be used as a way to break up the IP transport payload 1906 into UDP user data 1914 and a surplus area 1916 (also referred to as a UDP options area). In other words, the surplus area 1916 may be created when the UDP length field indicates a smaller transport payload than implied by the IP header 1904. In IPv4, for example, the IP Total Length field indicates the total IP datagram length (including the IP header 1904) and the size of the IP options is indicated in the IP header (in 4-byte words) as the “Internet Header Length” (IHL). As a result, the typical (and largest valid) value for the UDP Length is: UDP_Length=IPv4_Total_Length−IPv4_IHL*4. In IPV6, for example, the IP Payload Length field indicates the transport payload after the base IPv6 header, which includes the IPV6 extension headers and space available for the transport protocol. The lengths of any additional IP extensions are indicated within each extension, so the typical (and largest valid) value for the UDP Length is: UDP_Length=IPv6_Payload_Length−sum (extension header lengths).

The surplus area 1916 may be used for UDP options 1918. An UDP option 1918 is an extension to UDP to communicate remote parameters or support optional transport functions to on-path network elements 1104. In an embodiment, the application metadata 1810 discussed above may be carried (i.e., inserted in or comprises) as a UDP option 1918 in a UDP packet 1908. One technical benefit is the UDP options extension may be used to disseminate explicit signals to on-path network elements 1104.

### Example 1

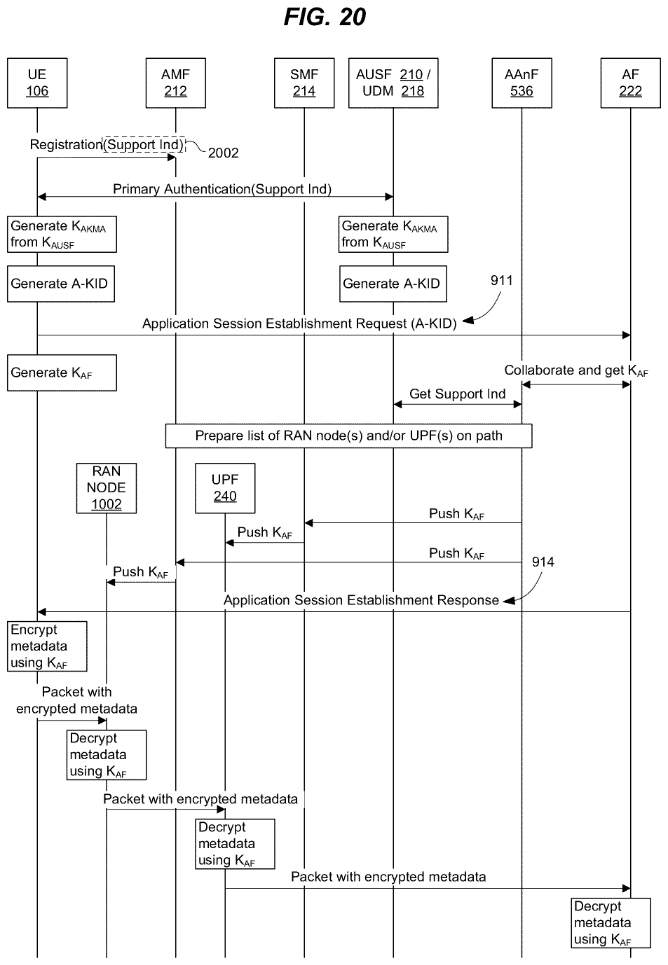

FIG. 20 is a signaling diagram illustrating K_{AF}-based encryption in an illustrative embodiment. Thus, in this example, the K_{AF} key 905 is used in encrypting application metadata 1810 of an explicit signal 1124 to on-path network elements 1104 (i.e., RAN node(s) 1002 and/or UPF(s) 240). To begin, UE 106 provides an indicator (referred to as a support indicator 2002) to 5GC 104 indicating whether UE 106 supports a metadata encryption scheme (e.g., to encrypt application metadata in a UDP option). UE 106 may provide the support indicator 2002 over a NAS payload to AMF 212 in a registration request message, and AMF 212 may provide the same to UDM 218 during the registration. Alternatively, UE 106 may provide the support indicator 2002 to AUSF 210/UDM 218 during primary authentication (i.e., in an authentication message).

In a non-roaming case, when UE 106 requests an application session from AF 222 with the A-KID 804 (e.g., sends the Application Session Establishment Request message 911 to AF 222), the AF 222 collaborates with the 5GC 104 to authenticate the UE 106 and retrieve the K_{AF} key 905 from AAnF 536. When validation is successful, AAnF 536 retrieves the UE capability of encrypting application metadata 1810, such as by retrieving the support indicator 2002 from UDM 218. When UE 106 supports the metadata encryption scheme, AAnF 536 prepares the list of UPF(s) 240 and/or RAN node(s) 1002 involved in the user plane network path 1024. For example, AMF 212 stores information regarding RAN nodes 1002 provisioned on the user plane network path 1024 for the application session, and SMF 214 stores information regarding UPFs 240 provisioned on the user plane network path 1024 for the application session. Thus, AAnF 536 may query AMFs 212 and SMF 214 to compile the list of UPF(s) 240 and/or RAN node(s) 1002.

AAnF 536 then disseminates the K_{AF} key 905 to UPF(s) 240 and/or RAN node(s) 1002 in the list as keying material 1812. In this embodiment, AAnF 536 is an example of a control plane NF 110 as described above. To do so, AAnF 536 pushes the K_{AF} key 905 to one or more UPFs 240 provisioned on the user plane network path 1024 via SMF 214, and/or pushes the K_{AF} key 905 to one or more RAN nodes 1002 provisioned on the user plane network path 1024 via AMF(s) 212. For a UPF 240, AAnF 536 may subscribe to UDM 218 to be notified whenever a new SMF 214 is registered, and push the K_{AF} key 905 to a UPF 240 via SMF 214. For a RAN node 1002, AAnF 536 may subscribe to UDM 218 to be notified whenever a new AMF 212 is registered, and push the K_{AF} key 905 to a RAN node 1002 via AMF 212. An AMF 212 may ensure that when UE 106 moves to a new RAN 102, the AMF 212 provides the K_{AF} key 905 to RAN node(s) 1002 in the new RAN 102. SMF 214 may ensure that when a new UPF 240 is selected, the SMF 214 provides the K_{AF} key 905 to the new UPF 240. AAnF 536 may repeat the process of disseminating the K_{AF} key 905 for each application session request because for each AF 222, a new K_{AF} key 905 is generated and the new K_{AF} key 905 needs to be pushed to registered SMFs/UPFs.

For the application session, the UE 106 also generates the K_{AF} key 905. After the application session establishment is completed, UE 106 determines whether to provide application metadata 1810 to on-path network elements 1104 for the application session. If so, UE 106 encrypts the application metadata 1810 using the K_{AF} key 905. In this example, it is assumed that UE 106 transmits user data for the application session in a UDP packet 1908 carried in an IP packet 1902. UE 106 derives an encryption key 1816 using the K_{AF} key 905, encrypts the application metadata 1810 with the encryption key 1816, and inserts the encrypted application metadata 1810 in the surplus area 1916 of the UDP payload 1912 (see FIG. 19). In other words, the encrypted application metadata 1810 is sent as a UDP option 1918 of the UDP packet 1908. UE 106 then sends the IP packet 1902 over the user plane network path 1024, such as toward the application service 1010 (see FIG. 10).

A RAN node 1002 on the user plane network path 1024 receives the IP packet 1902 with the encrypted application metadata 1810. RAN node 1002 uses the K_{AF} key 905 to decrypt the encrypted application metadata 1810 available in the UDP packet 1908. For example, RAN node 1002 derives a decryption key 1818 from the K_{AF} key 905, and decrypts the encrypted application metadata 1810 using the decryption key 1818. RAN node 1002 then performs a function associated with the application session based on the decrypted application metadata 1810. For example, the RAN node 1002 may provide a differentiated network service, such as QoS, based on the decrypted application metadata 1810. Similarly, a UPF 240 on the user plane network path 1024 receives the IP packet 1902 with the encrypted application metadata 1810. UPF 240 uses the K_{AF} key 905 to decrypt the encrypted application metadata 1810 available in the UDP packet 1908, and performs a function associated with the application session based on the decrypted application metadata 1810. For example, the UPF 240 may provide a differentiated network service, such as QoS, based on the decrypted application metadata 1810. Optionally, AF 222 on the user plane network path 1024 receives the IP packet 1902 with the encrypted application metadata 1810, and uses the K_{AF} key 905 to decrypt the encrypted application metadata 1810 available in the UDP packet 1908. One technical benefit is a shared keying material (i.e., the K_{AF} key 905) is distributed to on-path network elements 1104 for an application session so that an endpoint may send explicit signals to the on-path network elements 1104 in the form of encrypted application metadata (i.e., encrypted UDP options).

When the UE 106 does not support the metadata encryption scheme but the metadata encryption scheme is supported by a trusted AF 222, the K_{AKMA} key 803 may be distributed to the RAN node(s) 1002 and/or UPF(s) 240 as keying material 1812. This may be beneficial for one-way streaming content, such as video streaming.

### Example 2

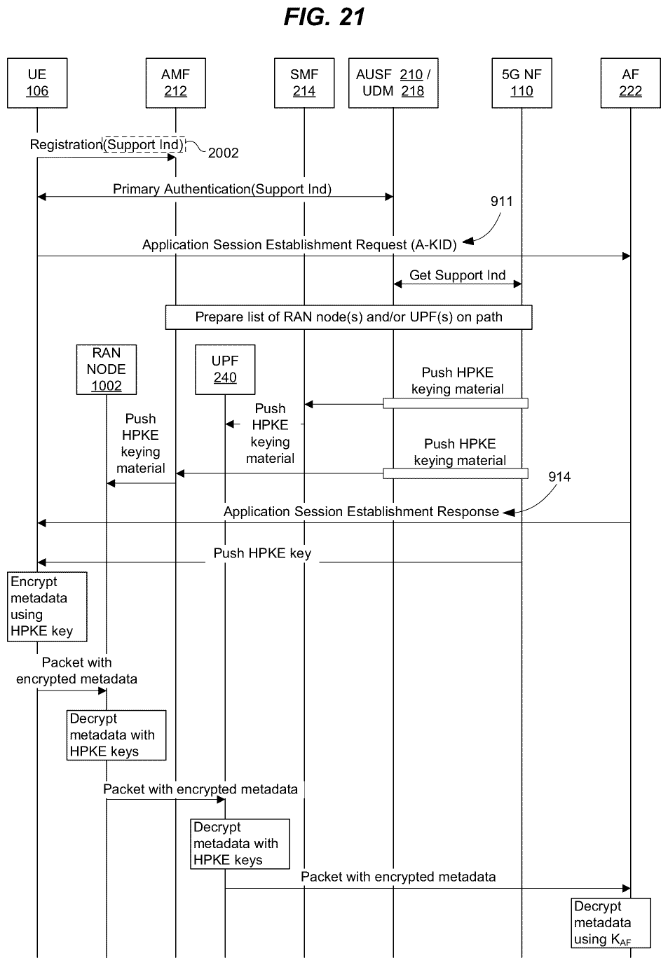

FIG. 21 is a signaling diagram illustrating HPKE-based encryption in an illustrative embodiment. Thus, in this example, an HPKE key is used in encrypting application metadata of an explicit signal to on-path network elements 1104 (i.e., RAN node(s) 1002 and/or UPF(s) 240). To begin, UE 106 provides an indicator (referred to as a support indicator 2002) to 5GC 104 indicating whether UE 106 supports a metadata encryption scheme (e.g., to encrypt application metadata in a UDP option). UE 106 may provide the support indicator 2002 over a NAS payload to AMF 212 in a registration request message, and AMF 212 may provide the same to UDM 218 during the registration. Alternatively, UE 106 may provide the support indicator 2002 to AUSF 210/UDM 218 during primary authentication (i.e., in an authentication message).

In a non-roaming case, UE 106 requests an application session from AF 222 with the A-KID 804 (e.g., sends the Application Session Establishment Request message 911 to AF 222). UDM 218 (or any new NF or existing NF 110) retrieves the UE capability of encrypting application metadata, such as by retrieving or identifying the support indicator 2002 provided by UE 106. When UE 106 supports the metadata encryption scheme, UDM 218, for example, prepares the list of UPF(s) 240 and/or RAN node(s) 1002 involved in the user plane network path 1024. For example, AMF 212 stores information regarding RAN nodes 1002 provisioned on the user plane network path 1024 for the application session, and SMF 214 stores information regarding UPFs 240 provisioned on the user plane network path 1024 for the application session. Thus, UDM 218 may query AMFs 212 and SMF 214 to compile the list of UPF(s) 240 and/or RAN node(s) 1002.

UDM 218 (or any new NF or existing NF 110) then disseminates HPKE keying material 1814 to UPF(s) 240 and/or RAN node(s) 1002 in the list. In this embodiment, a UDM 218 is an example of a control plane NF 110 as described above. To do so, UDM 218 pushes the HPKE keying material 1814 to one or more UPFs 240 provisioned on the user plane network path 1024 via SMF 214, and/or pushes the HPKE keying material 1814 to one or more RAN nodes 1002 provisioned on the user plane network path 1024 via AMF(s) 212. An AMF 212 may ensure that when UE 106 moves to a new RAN 102, the AMF 212 provides the HPKE keying material 1814 to RAN node(s) 1002 in the new RAN 102. SMF 214 may ensure that when a new UPF 240 is selected, the SMF 214 provides the HPKE keying material 1814 to the new UPF 240.

UDM 218 (or any new NF or existing NF 110) also pushes the HPKE keying material 1814 to the UE 106. For example, UDM 218 may invoke a UE Parameters Update (UPU) procedure to provide the HPKE keying material 1814 to the UE 106. UPU ensures that data is protected while delivering to the UE 106. Alternatively, UDM 218 may send the HPKE keying material 1814 to the AMF 212 serving UE 106, and AMF 212 delivers the HPKE keying material 1814 to UE 106 via NAS protocol (i.e., new payload in the NAS message).

After the application session establishment is completed, UE 106 determines whether to provide application metadata 1810 to on-path network elements 1104 for the application session. If so, UE 106 encrypts the application metadata 1810 using the HPKE keying material 1814. In this example, it is assumed that UE 106 transmits user data for the application session in a UDP packet 1908 carried in an IP packet 1902. UE 106 derives an encryption key 1816 using the HPKE keying material 1814, and encrypts the application metadata 1810 for the application session with the encryption key 1816. The HPKE keying material 1814 includes a Key Identifier, KEM ID, HPKE Public Key, and HPKE Symmetric Algorithms. UE 106 generates an ephemeral public key (pkE) to perform the encryption, and inserts the encrypted application metadata 1810 in the surplus area 1916 of the UDP payload 1912 (see FIG. 19). In other words, the encrypted application metadata 1810 is sent as a UDP option 1918 of the UDP packet 1908. UE 106 also inserts the ephemeral public key (pKE) as a UDP option 1918. UE 106 then sends the IP packet 1902 over the user plane network path 1024, such as toward the application service 1010 (see FIG. 10).

A RAN node 1002 on the user plane network path 1024 receives the IP packet 1902 with the encrypted application metadata 1810 and the ephemeral public key (pKE). RAN node 1002 derives a decryption key 1818 using the HPKE keying material 1814 and the ephemeral public key (pKE). RAN node 1002 then decrypts the encrypted application metadata 1810 using the decryption key 1818, and performs a function associated with the application session based on the decrypted application metadata 1810. For example, the RAN node 1002 may provide a differentiated network service, such as QoS, based on the decrypted application metadata 1810. Similarly, a UPF 240 on the user plane network path 1024 receives the IP packet 1902 with the encrypted application metadata 1810 and the ephemeral public key (pKE). UPF 240 derives a decryption key 1818 using the HPKE keying material 1814 and the ephemeral public key (pKE). UPF 240 then decrypts the encrypted application metadata 1810 using the decryption key 1818, and performs a function associated with the application session based on the decrypted application metadata 1810. For example, the RAN node 1002 may provide a differentiated network service, such as QoS, based on the decrypted application metadata 1810. Optionally, AF 222 on the user plane network path 1024 receives the IP packet 1902 with the encrypted application metadata 1810, and uses the HPKE keying material 1814 to decrypt the encrypted application metadata 1810 available in the UDP packet 1908. One technical benefit is shared keying material 1812 (i.e., the HPKE key material) is distributed to on-path network elements 1104 for an application session so that an endpoint may send explicit signals to the on-path network elements 1104 in the form of encrypted application metadata (i.e., encrypted UDP options).

When the UE 106 does not support the metadata encryption scheme but the metadata encryption scheme is supported by a trusted AF 222, the K_{AKMA} key 803 may be distributed to the RAN node(s) 1002 and/or UPF(s) 240 as keying material 1812. This may be beneficial for one-way streaming content, such as video streaming.

The above examples were provided for a non-roaming scenario. A roaming scenario is also similar to the non-roaming scenario, with HPLMN pushing the K_{AF} key or the HPKE key to the VPLMN SMF/UPF and AMFs. That way, the key material is available to the VPLMNs RAN nodes 1002 and UPF 240 along with HPLMN UPFs 240.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof.

What is claimed is:

1. A method of sending application metadata to on-path network elements provisioned for an application session, the method comprising:
establishing the application session between an application client running on user equipment, and an application service;
identifying the application metadata associated with the application session;
formatting a transport protocol packet with the application metadata;
deriving an encryption key based on keying material;
encrypting the application metadata in the transport protocol packet using the encryption key; and
sending the transport protocol packet over a user plane network path comprising one or more of the on-path network elements.

2. The method of claim 1, wherein the deriving comprises:
deriving the encryption key from an authentication and key management for application key derived during primary authentication of the user equipment.

3. The method of claim 1, wherein the deriving comprises:
deriving the encryption key from hybrid public-key encryption keying material received from at least a 5G core network.

4. The method of claim 1, further comprising:
determining, at a control plane network function of at least a 5G core network, whether the user equipment supports a metadata encryption scheme;
identifying, at the control plane network function, when the user equipment supports the metadata encryption scheme, the on-path network elements provisioned on the user plane network path of the application session;
identifying, at the control plane network function, the keying material; and
sending the keying material to the one or more of the on-path network elements.

5. The method of claim 4, further comprising:
receiving, at the control plane network function, a support indicator from the user equipment during primary authentication indicating whether the user equipment supports the metadata encryption scheme.

6. The method of claim 4, wherein the identifying the on-path network elements comprises:
compiling a list of one or more user plane functions and/or one or more radio access network nodes on the user plane network path.

7. The method of claim 4, wherein the sending the keying material comprises:
pushing the keying material to a session management function, which in turn pushes the keying material to a user plane function on the user plane network path.

8. The method of claim 4, wherein the sending the keying material comprises:
pushing the keying material to an access and mobility management function, which in turn pushes the keying material to a radio access network node on the user plane network path.

9. The method of claim 4, further comprising:
receiving, at one of the on-path network elements, the keying material sent by the control plane network function;
receiving, at the one of the on-path network elements, the transport protocol packet sent on the user plane network path;
deriving, at the one of the on-path network elements, a decryption key based on the keying material received from the control plane network function;
decrypting, at the one of the on-path network elements, the encrypted application metadata in the transport protocol packet using the decryption key; and
performing, at the one of the on-path network elements, a function associated with the application session based on the decrypted application metadata.

10. The method of claim 9, wherein the performing the function comprises:
applying a quality of service for the application session based on the decrypted application metadata.

11. The method of claim 1, wherein:
the transport protocol packet comprises a user datagram protocol packet; and
the encrypted application metadata comprises a user datagram protocol option of the user datagram protocol packet.

12. A 5G system that supports sending of application metadata to on-path network elements provisioned for an application session, the 5G system comprising at least one processor; and at least one memory storing instructions that, when executed by the at least one processor, cause the 5G system at least to perform:
establishing, at user equipment, the application session between an application client running on the user equipment, and an application service;
identifying, at the user equipment, the application metadata associated with the application session;
formatting, at the user equipment, a transport protocol packet with the application metadata;
deriving, at the user equipment, an encryption key based on keying material;
encrypting, at the user equipment, the application metadata in the transport protocol packet using the encryption key; and
sending, at the user equipment, the transport protocol packet over a user plane network path comprising one or more of the on-path network elements.

13. The 5G system of claim 12, wherein deriving an encryption key comprises:
deriving the encryption key from an authentication and key management for application key derived during primary authentication of the user equipment.

14. The 5G system of claim 12, wherein the deriving an encryption key comprises:
deriving the encryption key from hybrid public-key encryption keying material received from at least a 5G core network.

15. The 5G system of claim 12, further caused to perform:
determining, at a control plane network function of at least a 5G core network, whether the user equipment supports a metadata encryption scheme;
identifying at the control plane network function, when the user equipment supports the metadata encryption scheme, the on-path network elements provisioned on the user plane network path of the application session;
identifying, at the control plane network function, the keying material; and
sending the keying material to the one or more of the on-path network elements.

16. The 5G system of claim 15, further caused to perform:
receiving, at the control plane network function, a support indicator from the user equipment during primary authentication indicating whether the user equipment supports the metadata encryption scheme.

17. The 5G system of claim 15, wherein identifying the on-path network elements comprises:
compiling a list of one or more user plane functions and/or one or more radio access network nodes on the user plane network path.

18. The 5G system of claim 15, wherein sending the keying material comprises:
pushing the keying material to a session management function, which in turn pushes the keying material to a user plane function on the user plane network path.

19. The 5G system of claim 15, wherein sending the keying material comprises:
pushing the keying material to an access and mobility management function, which in turn pushes the keying material to a radio access network node on the user plane network path.

20. The 5G system of claim 15, further caused to perform:
receiving, at one of the on-path network elements, the keying material sent by the control plane network function;
receiving, at the one of the on-path network elements, the transport protocol packet sent on the user plane network path;
deriving, at the one of the on-path network elements, a decryption key based on the keying material received from the control plane network function;
decrypting, at the one of the on-path network elements, the encrypted application metadata in the transport protocol packet using the decryption key; and
performing, at the one of the on-path network elements, a function associated with the application session based on the decrypted application metadata.
